(19) United States
(12) Patent Application Publication
(10) Pub. No.: US 2013/0140192 A1
(43) Pub. Date: Jun. 6, 2013

(54) Method of Producing a Lipid Bilayer and Microstructure and Measuring Arrangement

(71) Applicants: Jan Behrends, Stegen (DE); Gerhard Baaken, Freiburg (DE)

(72) Inventors: Jan Behrends, Stegen (DE); Gerhard Baaken, Freiburg (DE)

(73) Assignee: ALBERT-LUDWIGS-UNIVERSITÄT FREIBURG, Freiburg (DE)

(21) Appl. No.: 13/702,802

(22) PCT Filed: Jun. 1, 2011
(86) PCT No.: PCT/EP11/02738

§ 371 Date: Feb. 19, 2013

(30) Foreign Application Priority Data
Jun. 7, 2010 (DE) 10 2010 022 929.6

(51) Int. Cl. G01N 27/22

(52) U.S. Cl. CPC G01N 27/22
USPC 205/792; 204/403.01; 204/403.06

(57) ABSTRACT

The present invention relates to a method of producing a lipid bilayer over a microcavity open on one side and to a microstructure for investigating lipid bilayers and an associated measuring arrangement. The method of producing a lipid bilayer over a microcavity open on one side comprises the following steps: filling the microcavity with an electrolyte solution; moving a fluid containing dissolved lipids in a first direction onto the microcavity; moving the fluid in a second direction away from the microcavity; monitoring the formation of the lipid bilayer over the microcavity by detecting an impedance between a counter-electrode connected to the fluid and a measuring electrode, which is arranged inside the microcavity. The microstructure has a substrate, in which at least one microcavity is formed, wherein at least one measuring electrode is arranged inside the microcavity and wherein the at least one microcavity can be connected to a fluid channel so that a laminar flow of fluid can be made to flow over the microcavity with at least two different directions of flow.

The present invention relates to a method for facilitated production of a lipid bilayer over a microcavity open on one side and to a microstructure and a measuring arrangement, which make this kind of simplified and facilitated production of lipid bilayers possible.

Synthetic lipid bilayers are interesting for research and industry for many reasons. They are models for cell membranes, with which the biological functions of reconstituted membrane proteins can be investigated especially precisely. After having already been used, shortly before the development of the so-called patch-clamp technique, to measure currents through individual ion channels in membranes, this model system has increasingly undergone a renaissance just in recent years. One reason for this is the successful miniaturization of systems for production of and measurement on these lipid bilayers [see for example: Wonderlin, W. F.; Finkel, A.; French, R. J., Biophys J, 1990 58, (2), 289-297; Akeson, M.; Branton, D.; Kasianowicz, J. J.; Brandin, E.; Deamer, D. W., Biophys J, 1999 77, (6), 3227-3233; Pantoja, R.; Sigg, D.; Blunck, R.; Bezanilla, F.; Heath, J. R., Biophys J, 2001 81, (4), 2389-239; Pantoja, R.; Nagarah, J. M.; Starace, D. M.; Melosh, N. A.; Blunck, R.; Bezanilla, F.; Heath, J. R., Biosens Bioelectron, 2004 20, (3), 509-517; Fertig, N.; Meyer, C.; Blick, R. H.; Trautmann, C.; Behrends, J. C., Phys Rev E, 2001 6404, (4); Fertig, N.; Klau, M.; George, M.; Blick, R. H.; Behrends, J. C., Appl Phys Lett, 2002 81, (25), 4865-4867; Fertig, N.; Blick, R. H.; Behrends, J. C., Biophys J, 2002 82, (6), 3056-3062; Mayer, M.; Kriebel, J. K.; Tosteson, M. T.; Whitesides, G. M., Biophys J, 2003 85, (4), 2684-2695; Malmstadt, N.; Nash, M. A.; Purnell, R. F.; Schmidt, J. J., Nano Lett, 2006 6, (9), 1961-1965; Sondermann, M.; George, M.; Fertig, N.; Behrends, J. C., Bba-Biomembranes, 2006 1758, (4), 545-551; Baaken, G.; Sondermann, M.; Schlemmer, C.; Ruhe, J.; Behrends, J. C., Lab Chip, 2008 8, (6), 938-44]. Besides a resultant definitely increased measurement resolution with respect to time and amplitude, in addition this miniaturization opened up the prospects of a greatly increased throughput of measurements in unit time through parallelization.

From the aspect of demand, the renaissance is due to at least two factors, namely the need, for pharmacological screening of active substances, to investigate channel and transporter proteins, which are barely accessible, if at all, for the patch-clamp technique (especially proteins in membranes of intracellular organelles) and the increasing use of bacterial pores as molecular Coulter counters and nanoreactors for single-molecule analysis (e.g. mass spectroscopy of polymers or DNA sequencing by the company Oxford Nanopore Technologies).

However, the potential of miniaturized lipid bilayers for high-throughput investigations has not so far been sufficiently exploited technically. As noted for example in the dissertation of Baaken, Gerhard: “Development of a microsystem-technical platform for parallel investigations of ion channels in artificial cell membranes”, Albert-Ludwig University, Freiburg, 2008, new benchmarks have indeed been set in recent years with the development of chip-based planar patch-clamp techniques with respect to miniaturization and integration density for highly parallel measurements on cell membranes; until now, however, for high-throughput investigations on synthetic membranes there has mainly been a lack of a simple and reproducible solution for the production of the lipid bilayers that can easily be automated. This has now become possible with the present invention. The newly developed method for automated production of lipid bilayers on microstructured cavities makes it possible, in a very simple way, to adapt existing equipment for high-throughput electrophysiology, to provide, in a short time, a complete system for fully automated, parallel measurements on lipid bilayers.

To summarize, the method to be presented here overcomes fundamental practical difficulties and disadvantages with respect to the generation of isolated lipid bilayers, which are of interest for answering fundamental questions of electrophysiology and for pharmacological screening of active substances.

Existing solutions have in particular the disadvantages explained below.

An essential step toward the automation of electrophysiological investigations on cell-physiological model membranes in general and subsequently on membrane proteins is to develop a method by which the production of isolated lipid bilayers over (small) apertures can be achieved easily and reproducibly without intervention by the experimenter.

For applying lipid bilayers on a surface or over an aperture, in the last thirty years basically two methods have become established: the painting technique (see e.g. Müller et al., Z Kreislaufforschung, 1963, 52 (7) 534 ff.), and the Langmuir-Blodgett technique.

The painting technique is indeed extremely simple to apply, but its success depends almost exclusively on the manual dexterity of the experimenter, and therefore automation of this method appears to be very difficult.

Application by means of the Langmuir-Blodgett technique and methods developed from that, or related methods, is largely used for transferring defined mono- or multimolecular layers onto a substrate surface. The authors of the article Takagi, M. A., K.; Kishimoto, U., Annu. Report Biol. Works Fac. of Sci. Osaka Univ, 1965 13, 107-110, and later the authors of the article Montal, M.; Mueller, P., Proceedings of the National Academy of Sciences, 1972 69, (12), 3561-3566, simplified this technique, so that today it is employed in many experiments for the production of bilipid membranes, as is shown for example in the article Danelon, C.; Lindemann, M.; Borin, C.; Fournier, D.; Winterhalter, M., IEEE Transactions Nanobioscience, 2004 3, (1), 46-48.

Basically, in this method, first an aperture in a thin hydrophobic substrate film that separates two compartments is wetted on both sides by filling with an electrolyte. Then after applying a drop of lipid solution directly on the surface of the aqueous electrolyte phase in one of the compartments, it is necessary to wait until most of the solvent has evaporated. Then the water level is lowered by removing volumes of electrolyte to below the aperture, and raised again. A lipid bilayer forms on the opening as a result of the hydrophobic/hydrophilic interactions. However, direct transfer of this method to planar substrates, such as appear to be essential for automation, is only conditionally possible. It is mainly the manipulation that is difficult, as the entire experimental setup after producing the lipid membrane must be stored completely in aqueous solution.

The authors of the article Malmstadt, N.; Nash, M. A.; Purnell, R. F.; Schmidt, J. J., Nano Lett, 2006 6, (9), 1961-1965, use microstructured channels in poly(dimethylsiloxane), PDMS, to produce a lipid membrane. This approach makes use of the permeability of PDMS to various solvents, for continuously reducing, by diffusion and evaporation, a volume of lipid solution that has been introduced into a microchannel, and thereby produce a lipid membrane between two aqueous phases.

In the approach of Suzuki, H.; Tabata, K. V.; Noji, H.; Takeuchi, S., Langmuir, 2006 22, (4), 1937-1942, and especially in the so-called air-exposure technique developed by the authors of the article Sandison, M. E.; Zagnoni, M.; Abu-Hantash, M.; Morgan, H., J Micromech Microeng, 2007 17, (7), p. 189-196, first both sides of a comparatively large aperture (>100 μm) are wetted with electrolyte solution by means of microfluidic inlets or by pipetting.

Then, as in the painting technique, a drop of lipid solution is deposited on the opening or supplied via a microfluidic channel. The aqueous phase is submitted to suction on one side, which makes a defined evaporation of the solvent in the air possible. By redispensing/supplying a drop of water onto the aperture, the membrane is preserved.

However, a feature that is common to all these known approaches is that the lipid bilayers can only be produced by interactions in the air phase or with complicated (micro)fluidic access from both sides, preferably with macroscopic pumps. Moreover, the conventional methods impose very particular requirements on the experimental setup. The expenditure for controlling and monitoring electrophysiological experiments is also increased considerably. Methodologically, these known methods are not able to solve fundamental practical problems with respect to the possibility of automation, speed and usability in generating lipid bilayers. In particular they are not suitable for producing lipid bilayers on very small apertures with fluidic access on only one side, which are the only type that can be considered for high-throughput applications.

Furthermore, from WO 2009/069608 A1, a method is known for producing a planar lipid bilayer membrane array, in which comb-shaped structures form microchambers, each of which opens into a microchannel. By sequential introduction of buffer solution and lipid solution by means of a microsyringe, lipid bilayers are formed in the boundary region between microchannel and microchamber. The system and method of production of lipid bilayers described in this document is far from being sufficiently reproducible and reliable for automation of the production of lipid bilayers, especially in planned applications in high-throughput investigations. However, with the known microstructure that is disclosed in WO 2009/069608 A1, in particular it is not possible to demonstrate the formation of a lipid bilayer unequivocally, i.e. by electrical measurement, as the necessary provision of the chambers with electrodes is missing. Instead, according to WO 2009/069608 A1, optical methods of measurement are employed, but on their own these do not permit unequivocal detection of a lipid bilayer.

Therefore the problem underlying the present invention is that of providing a rapid, reliable and simple, real-time-controlled method, suitable for being automated, for producing lipid bilayers and the microstructure that makes this possible, and the corresponding measuring arrangement, especially in a system suitable for high-throughput investigations.

This problem is solved by the object of the independent claims. Advantageous further embodiments of the present invention form the object of the dependent claims.

Moreover, the present invention is based on the finding that in experiments with a pipetting robot, it was found, surprisingly, that in some cases merely alternating application of lipid in alkane and electrolyte solution onto a microcavity with electrical contacts in a hydrophobic polymer layer leads to the formation of a lipid bilayer.

This extremely surprising, and at first rather rarely made observation led to considering whether possibly self-organizing effects at interfaces could be responsible for this, and to ask whether such effects might occur with greater probability if the movement of lipid and electrolyte were controlled geometrically, as is the case for example in a microchannel or for the movement of a defined hanging drop.

These experiments were successful to a very unexpected extent, in that a lipid bilayer with the characteristic high resistance and capacitance could be detected with high probability. Moreover, the existence of a lipid bilayer could be demonstrated by reconstitution of ion channels. For this, a small amount of lipid in a channel already filled with electrolyte was applied over a microcavity in hydrophobic polymer. The following strategy proved to be successful:

A microchannel already filled with aqueous electrolyte, at the bottom of which there are one or more microelectrode cavities, also filled with the same electrolyte, is charged with a small amount of lipid solution, followed once again by the same electrolyte. Owing to the laminar flow, the lipid and aqueous phase remain almost perfectly separate. Through further introduction of electrolyte solution, the lipid phase in the microchannel is pushed further over the opening or the well in the substrate. The lipid molecules of the lipid phase align according to their amphiphilic character on the interface to the aqueous phase corresponding to their hydrophobic and hydrophilic moieties. It is to be assumed that now, owing to this self-ordering process, a first lipid monolayer forms. Then a certain proportion of the electrolyte volume is withdrawn from the microchannel. Therefore the direction of flow of the fluids is reversed and the drop is pushed back from its position over the well or opening. The resultant necessarily formed parabolic flow profile leads, according to our current conception, to the application of a second lipid monolayer on the first and therefore to the formation of a lipid bilayer.

An important precondition for the surprisingly high success rate is, in addition to the hydrophobicity of the substrate material, the choice of the properties of the lipid solvent tailored to this application. On the one hand, there must be complete dissolution of the lipid molecules, i.e. the critical concentration for micelle formation (critical micelle concentration, CMC) should be as high as possible; on the other hand, the solvent (SOLV) used for dissolving the lipid should be very poorly miscible or immiscible with aqueous solutions. Hydrophobic solvents are preferably used, e.g. hexadecane, dodecane, decane, octane, hexane or pentane and mixtures of these substances, wherein the choice of the pure substances or the mixture is adapted to the dimensions of the cavity, so that formation of the lipid bilayer is as rapid and reliable as possible.

In contrast to the aforementioned disadvantages of existing solutions, in this method the formation or the existence of an interface to the air is not obligatory. Through the omission of a third interface, additional, uncontrollable disturbing factors are excluded. This leads to an increased yield in the successful generation of lipid bilayers. In addition there is a massive reduction in the cost of equipment relative to existing solutions, which sometimes require (micro)fluidic access both above and beneath the opening. This can overcome a marked limitation with respect to the design of microapertures, which excludes structures closed on one side, as are usually customary in microchip production. It is therefore possible to produce a lipid bilayer with only one pump or one pipette. Various lipid solutions can be introduced through a single inlet. The decisive advantage of the method is therefore that the lipid bilayers can be produced for example using simple, commercially available pipetting robots.

The arrangement and procedure according to the invention lead to the essential advantage of this method: a high degree of automation is possible.

Moreover, in microtechnical systems, lipid bilayers can be produced over several openings in a single step. From academic basic research to pharmacological screening of active substances, the stable, simple, rapid and reliable production of a lipid bilayer, as artificial model of a cell, is a decisive factor in the most varied of applications. For the latter, in particular high experimental throughputs are extremely important for general, productive development. Users from basic research benefit from the simplification in experimental runs, from reduced expenditure on apparatus and systems and from high variability in experiments with statistically improbable events with respect to the investigation of membrane proteins or of the model membrane itself. To summarize, it can be stated that for users in all electrophysiological and biophysical specializations, the method presented here increases efficiency in experiments with model cell membranes, as generally it makes their execution far less time-consuming.

According to an advantageous embodiment of the present invention, the measuring system comprises at least one electronic data acquisition and control system with control and evaluator units, which can in each case control the devices provided for the movement of the lipid phase in relation to the values of DC resistance, impedance and/or capacitance detected in real time. In this way, automatic or semi-automatic, feedback-controlled movement of the lipid phase onto the aperture and away from the aperture and automatically controlled formation of a lipid bilayer can be made possible.

For better comprehension of the present invention, it is explained in more detail on the basis of the practical examples presented in the following figures. Identical parts are provided with the same reference symbols and the same component designations. Furthermore, individual features or combinations of features from the embodiments shown and described can in themselves represent independent inventive solutions or solutions according to the invention. The figures show:

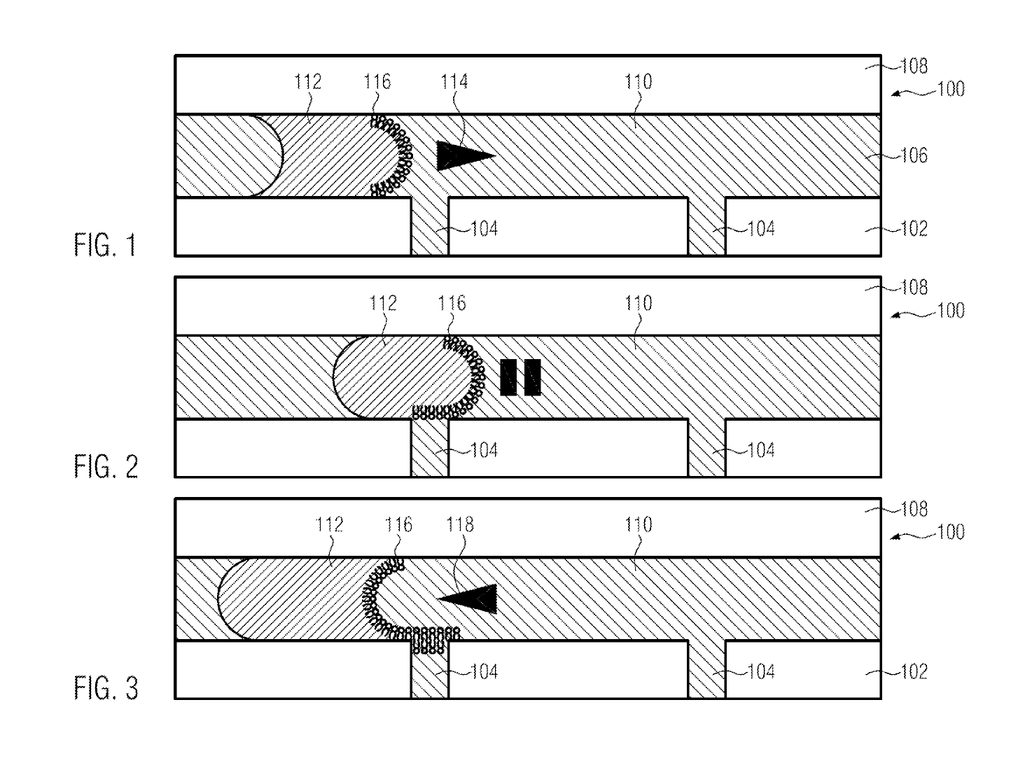

FIG. 1 a schematic sectional representation of a microstructure while lipid solution is flowing over it in a first direction of flow;

FIG. 2 a schematic sectional representation of the microstructure from FIG. 1 with the lipid solution stopped over a first cavity;

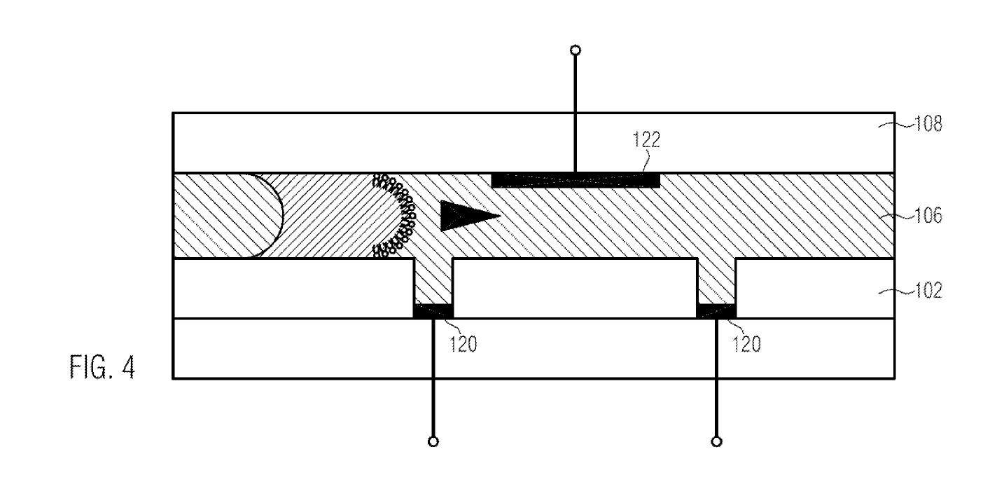

FIG. 3 a schematic sectional representation of the microstructure while lipid solution is flowing over it in a second direction of flow;

FIG. 4 a schematic sectional representation through a microstructure with an electrode arrangement for monitoring the production of the lipid bilayers;

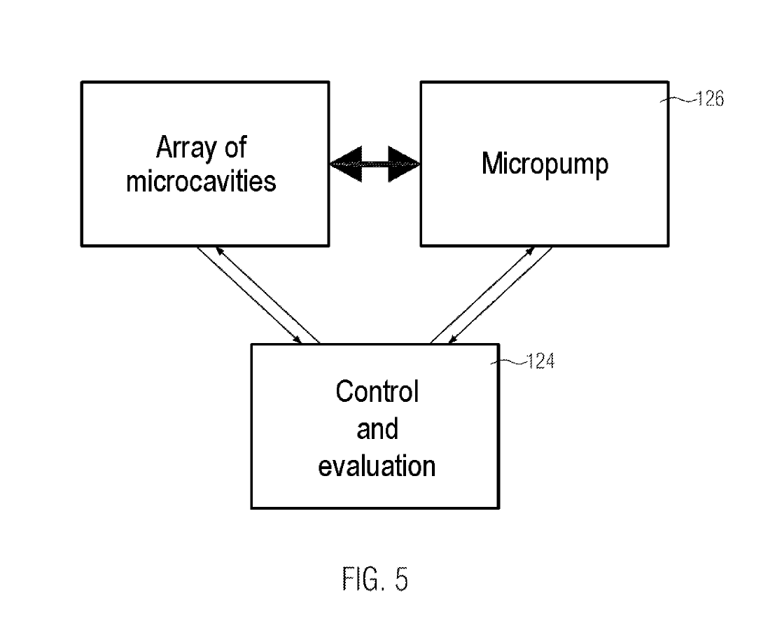

FIG. 5 a block diagram of a microstructure with integrated micropump;

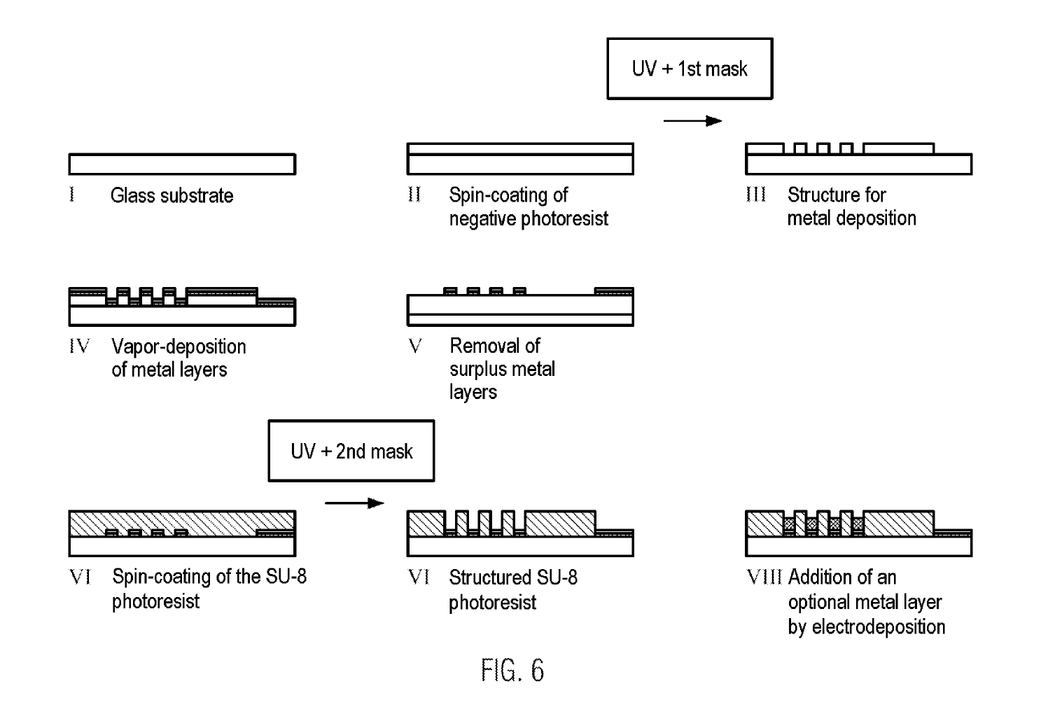

FIG. 6 an overview of a microtechnical method of production for producing the arrangement in FIG. 4;

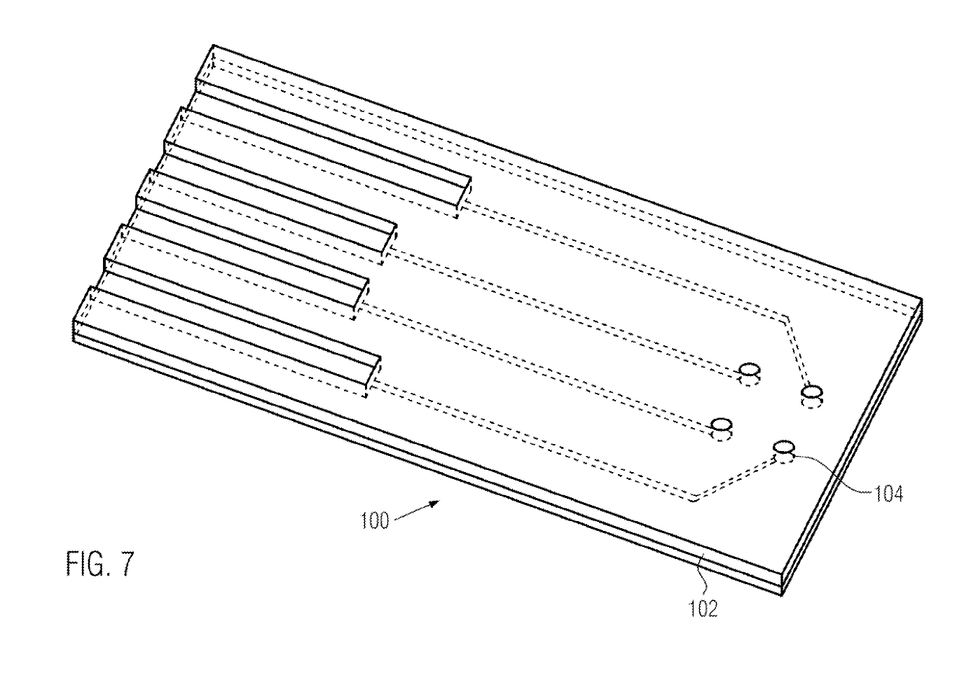

FIG. 7 a perspective view of a microstructure according to the invention with four microcavities;

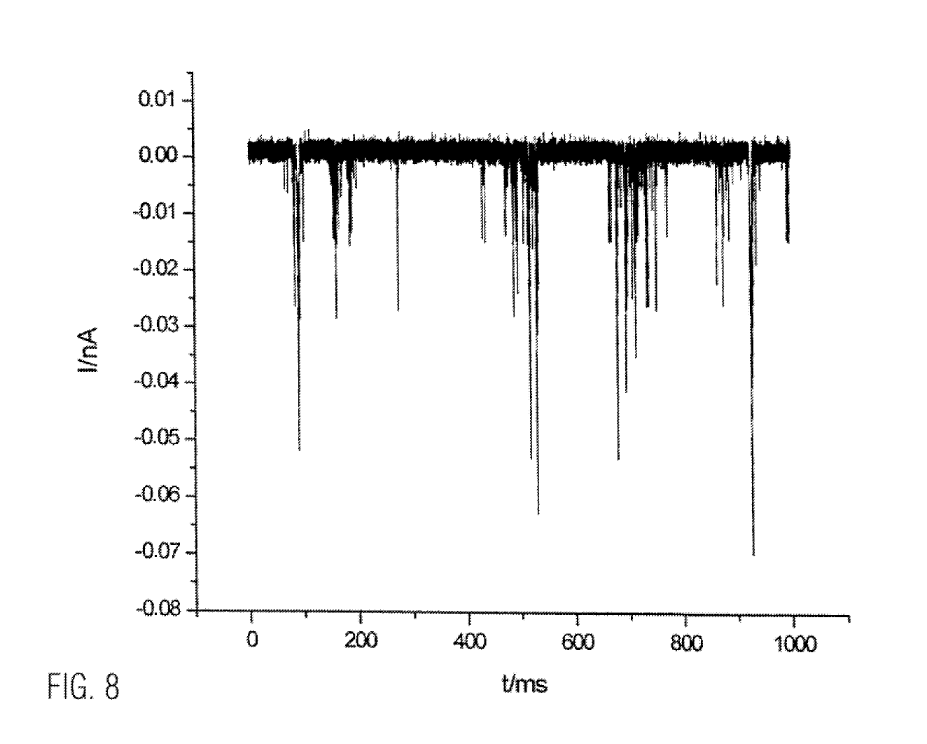

FIG. 8 an example of a time diagram, measured with the biological model system alamethicin

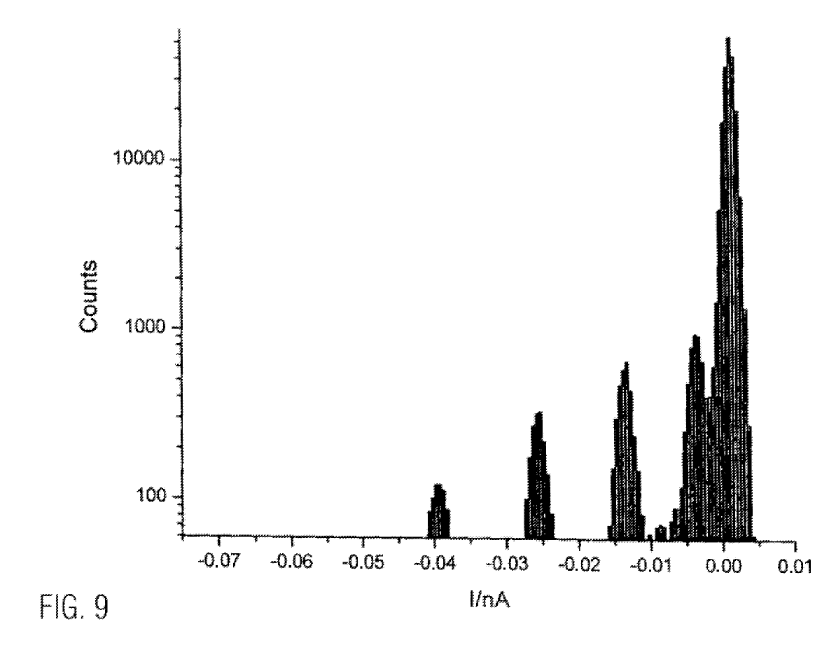

FIG. 9 a histogram of the measurement from FIG. 8;

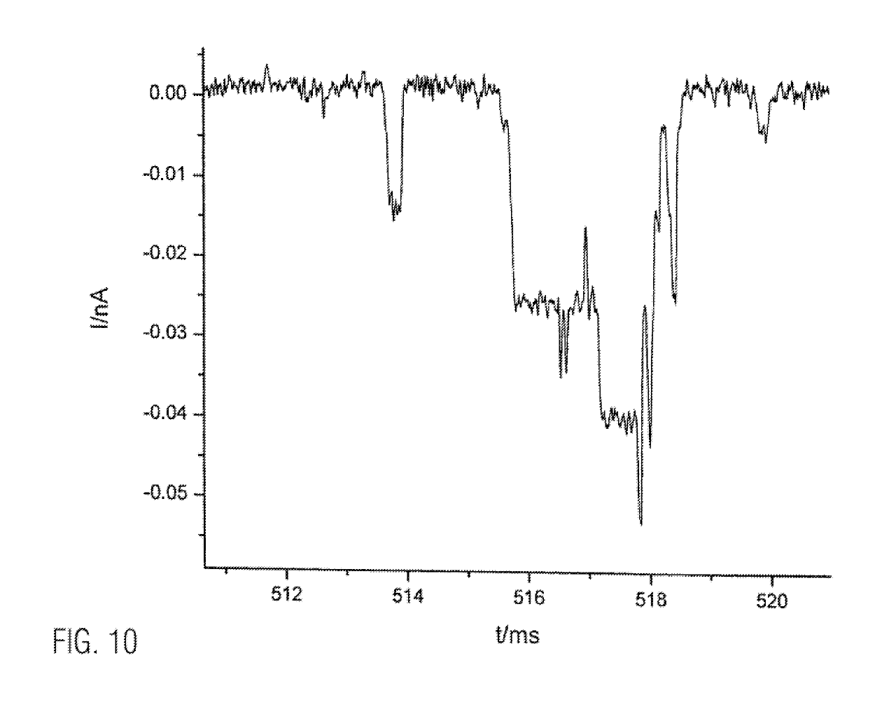

FIG. 10 a magnified extract of the measured results from FIG. 8.

FIG. 1 shows a microstructure 100 according to the invention during a first step in the production of lipid layers. In its simplest configuration, the microstructure 100 comprises a substrate 102, in which at least one microcavity 104 is formed. In the following, these microcavities 104 are also called wells, openings or apertures and denote cavities that are open on one side, which have dimensions of less than about a millimeter. These dimensions are mainly determined by the size of the freely suspended lipid layer spanning them that is still stable.

“Lipid layers” are understood in the following as membranes that consist of membrane-forming lipids. Membrane-forming lipids are lipids that possess a hydrophilic and a hydrophobic moiety—and are thus amphiphilic. This enables them, in polar solvents such as water, depending on their nature, to form either micelles (spherical aggregates of amphiphilic molecules, which cluster together spontaneously in a dispersing medium) or lipid bilayers—wherein it is always the hydrophilic moiety that interacts with the polar solvent. With the exception of the membranes of Archaea, all biomembranes, which delimit the contents of a cell from the environment, are formed from these lipid bilayers. In the present application, the terms bilipid layer, double lipid layer and lipid bilayer are used synonymously.

A microchannel 106 is arranged above the microcavities 104. The microchannel is delimited by a covering layer 108 on the side opposite the microcavities 104 and is for example formed in a cover plate.

According to the invention, the microchannel 106 and the microcavities 104 are first filled with an aqueous phase 110. As shown in FIG. 1, a lipid phase 112 is introduced into the aqueous phase 110. For example, by means of a micropump or a syringe, the lipid phase 112 is led over the first aperture 104 with formation of a laminar flow profile in direction 114 (onto the aperture). The lipid molecules 116 align themselves, as shown schematically, so that their hydrophilic ends are oriented toward the aqueous phase 110, whereas their lipophilic ends are oriented toward the lipid phase 112. The material of the substrate 102 then either consists completely of hydrophobic material or is surface-coated, so that a hydrophobic surface is presented to the lipid molecules.

As is illustrated schematically in FIG. 2, in the next process step, passage over the microcavity 104 stops and a lipid monolayer can form over the opening of the microcavity 104.

According to the invention, by reversing the pump pressure, the lipid phase 112 is now moved away from the aperture 104 in the opposite direction 118 once again with formation of a laminar flow profile. As shown schematically in FIG. 3, the desired lipid bilayer forms over the water-filled microcavity 104. This formation of lipid bilayers, which—as will be seen more clearly from later statements—is reproducible, arises through the directed movement of a defined volume of a lipid solution over the cavity and away from it again.

Furthermore, as can be seen from FIG. 4, the movement of the volume of lipid solution can be provided with direct feedback with the measured electrical parameters, in particular the ohmic resistance and the capacitance.

The microstructure according to FIG. 4 comprises, in addition to the components already explained with reference to FIGS. 1, 2 and 3, at least one measuring electrode 120, and at least one counter-electrode 122. By means of this arrangement, measurements can be undertaken, as described in the dissertation of Baaken, Gerhard: “Development of a microsystem-technical platform for parallel investigations of ion channels in artificial cell membranes”, Albert-Ludwig University, Freiburg im Breisgau, November 2008.

In particular, by applying a defined, time-variable potential difference, the flow of current between the measuring electrode 120 present in the cavity and the counter-electrode 122 located outside of the cavity 104 can be detected. The different electrical conductivities of the aqueous electrolyte phase 110 and of the hydrophobic solvent 112 cause changes in the current amplitude. This can be used according to the invention for detecting the volume of hydrophobic solvent above the cavity and can, if there is direct connection to an electrically controllable pump, provide feedback to the pump. Furthermore, the proper functional capacity of the lipid bilayer applied can be verified directly.

A precious metal, for example gold, may come into consideration as the electrode material for the electrodes 120. Preferably, however, in order to transform the electrochemical behavior of the polarizable gold electrodes by means of a microgalvanic coating into the behavior of a nonpolarizable electrode, the gold electrode can be coated so that it represents a silver/silver chloride electrode. This can be carried out for example according to the methods from the aforementioned dissertation of Baaken. The counter-electrode 122 can also be provided with a corresponding coating, in order to form a silver/silver chloride electrode and thus obtain a stable reference potential. Other possible embodiments of the electrodes comprise coating with platinum black or iridium oxide.

As shown schematically in FIG. 5, a corresponding pump 126 can be controlled directly with said electrode system and an associated control and evaluating unit 124. A closed control circuit of this kind makes fully automated coating of these microstructures possible. Of course, pump 126 does not have to be a micropump, but can be of any other suitable form. However, by providing a micropump, it is possible for the microstructure to be produced as an integrated microsystem with the microcavities 104 together with the pump and optionally also together with the electronics of the control and evaluating unit 124.

The production of a microstructure with four microcavities 104 will now be explained, referring to FIGS. 6 and 7.

In a first step, a substrate, for example of glass, is prepared. Spin coating and exposure of a negative photoresist provides a mask for the deposition of the metal layers for the measuring electrodes 120. These are produced, as shown in step IV, for example by vapor deposition. In step V, the layer of photoresist is removed, thus removing the surplus metal areas. According to the invention, the wall of the microcavities 104 consists of SU8 photoresist. This can be produced directly with the desired structures by a photographic technique. As shown in step VIII, using electrodeposition, the necessary metallization can now be applied for producing a silver/silver chloride electrode.

FIG. 7 shows a perspective view of the resultant chip, which is made into a closed system by applying a covering layer, e.g. in the form of another glass structure. In this covering layer, which is not shown separately here, in addition the channel structures are produced, which for example join together in each case two of the apertures 104 corresponding to the arrangement in FIGS. 1 to 3.

Using the model protein alamethicin described in Chapter 4 of the dissertation of Baaken, Gerhard: “Development of a microsystem-technical platform for parallel investigations of ion channels in artificial cell membranes”, Albert-Ludwig University, Freiburg im Breisgau, November 2008, it can be proved that functionally active lipid bilayers have in fact formed over the apertures. FIGS. 8, 9 and 10 show, as an example, the results of a measurement that was carried out on the microstructures according to the invention.

Experiments were conducted in which lipid bilayers with incorporated alamethicin channels were applied and were measured. As described in detail in Baaken's dissertation, alamethicin forms pores in membranes, and indeed exclusively in lipid bilayers, in relation to an applied transmembrane potential. Therefore by applying a potential between the measuring electrode 120 and the counter-electrode 122, a flow of current through the pores in the bilipid membrane can be measured. If alamethicin channels are successfully incorporated in the lipid layers spanning over the well, the measured current shows typical fluctuations, which resemble a step function with different conductivity steps. These different conductivity steps represent pores with a different number of alamethicin monomers.

FIG. 8 shows an overview of the variation of current at constant holding voltage as a function of time. FIG. 9 is a histogram of the measured values from FIG. 8, which proves that an electrically very highly resistive layer has formed, and FIG. 10 is a magnified extract of the time range between 510 and 520 ms. In particular the stepped shape of the variation of current in FIG. 10 represents, in agreement with the results of Baaken's dissertation, the characteristic curve for a functioning bilipid membrane with alamethicin pores incorporated in it. This behavior rules out that merely a disordered accumulation of protein is responsible for the high insulation resistance.

The measured results in FIGS. 8 to 10 thus demonstrate unequivocally that with the method of production according to the invention, a functional lipid bilayer was produced over the corresponding well in the channel.

1-29. (canceled)

30. A method of producing a lipid bilayer over a microcavity that is open on one side and is formed in a substrate, with the following steps:
filling the microcavity and partially covering the substrate containing the microcavity with an electrolyte solution, so that there is continuity between the electrolyte solution in the microcavity and the electrolyte solution on the substrate;
moving a fluid containing dissolved lipids, which forms a lipid phase, within the aqueous electrolyte solution covering the substrate, in a first direction onto the microcavity;
setting and monitoring the position of the lipid phase on the microcavity by detecting an increased DC resistance or an impedance between a connected counter-electrode located outside the cavity and a measuring electrode, which is arranged inside the microcavity;
moving the lipid phase in a second direction away from the microcavity;
monitoring the formation of the lipid bilayer over the microcavity by detecting a DC resistance, an impedance and/or a capacitance between a counter-electrode connected to the fluid and a measuring electrode, which is arranged inside the microcavity.

31. The method as claimed in claim 30, wherein the moving of the lipid phase takes place in a fluid flow.

32. The method as claimed in claim 31, wherein the first and the second direction are in opposite directions and the flow is laminar.

33. The method as claimed in claim 30, wherein the moving of the lipid phase takes place through the movement of a hanging drop of this fluid.

34. The method as claimed in claim 33, wherein the hanging drop adheres to a movable pipette or to a planar substrate suitable for moving a drop.

35. The method as claimed in claim 30, wherein for detecting the impedance between the measuring electrode and the counter-electrode, a defined time-variable electric potential difference is applied and a variation of an amplitude of an electric current between the electrodes is monitored.

36. The method as claimed in claim 35, wherein the time-variable voltage difference has the form of square-wave pulses with amplitudes between 1 and 100 mV, preferably between 1 and 30 mV, and a duration from 5 ms to 500 ms, or
wherein the time-variable voltage difference has the form of ramps with a peak amplitude between 1 and 100 mV, preferably between 1 and 30 mV, and a duration from 5 ms to 500 ms, or
wherein the time-variable voltage difference has the form of a sine curve with a peak-to-peak amplitude from 1 to 500 mV and a frequency from 0.1 Hz to 1 MHz, preferably from 1 Hz to 20 KHz.

37. The method as claimed in claim 30, wherein the fluid comprises a hydrophobic solvent.

38. The method as claimed in claim 37, wherein the hydrophobic solvent comprises hexadecane, dodecane, decane, octane, hexane or pentane and mixtures of these substances, wherein the choice of the pure substances or the mixture is adapted to the dimensions of the cavity so that formation of the lipid bilayer is as rapid and reliable as possible.

39. The method as claimed in any one of the preceding claims, wherein the ohmic resistance and the capacitance between the measuring electrode and the counter-electrode are monitored.

40. A measuring arrangement, containing a microstructure for investigating lipid bilayers, wherein the microstructure (100) has a substrate (102), in which at least one microcavity open on one side (104) is formed, wherein at least one measuring electrode (120) is arranged inside the microcavity (104) and wherein the at least one microcavity (104) is connected to a fluid channel (106) in such a way that a laminar flow of fluid can be made to flow over the microcavity in at least two different directions of flow,
wherein the at least one measuring electrode and at least one counter-electrode are connected to an amplifier suitable for measurements of electrical resistance, impedance and/or capacitance, preferably a potentiostat, voltage-clamp or patch-clamp amplifier,
wherein an electronic data acquisition and control system is provided with control and evaluator units, in order to control the devices provided in each case for the movement of the lipid phase onto the microcavity and away from the microcavity as a function of values of DC resistance, impedance and/or capacitance detected in real time.

41. The measuring arrangement as claimed in claim 40, wherein the measuring electrode forms the bottom of the cavity.

42. The measuring arrangement as claimed in claim 40, wherein at least one counter-electrode (122) is arranged outside of the microcavity, for electrically contacting the fluid that covers the substrate.

43. The measuring arrangement as claimed in claim 42, wherein the at least one counter-electrode is located in a fluid channel (106) or is connected electrically to the latter.

44. The measuring arrangement as claimed in claim 40, wherein a plurality of microcavities (104) arranged to form an array is provided in the substrate (102).

45. The measuring arrangement as claimed in claim 44, wherein each of the plurality of microcavities (104) has at least one measuring electrode (120) capable of being electrically contacted separately.

46. The measuring arrangement as claimed in claim 40, further comprising a micropump (126) for bidirectional delivery of the fluid.

47. The measuring arrangement as claimed in claim 46, wherein the micropump (126) is integrated in the substrate (102).

48. The measuring arrangement as claimed in claim 40, wherein the substrate (102) is made from a hydrophobic material or is provided with a hydrophobic surface coating.

49. The measuring arrangement as claimed in claim 48, wherein the substrate (102) is formed by a photostructurable epoxide resin on a glass support.

50. The measuring arrangement as claimed in claim 49, wherein the at least one measuring electrode (120) is formed by a circuit-board conductor structure on the glass support.

51. The measuring arrangement as claimed in claim 40, wherein the at least one measuring electrode (120) is a silver/silver chloride electrode.

52. The measuring arrangement as claimed in claim 40, wherein the at least one microcavity has a maximum diameter from 1 μm to 300 μm, preferably 2 μm to 100 μm, and an aspect ratio between 0.1 and 100, preferably between 0.3 and 10.

53. The measuring arrangement as claimed in claim 40, wherein the microstructure is integrated in an upright or inverted microscope for optical examination and analysis of the lipid bilayer.

54. The measuring arrangement as claimed in claim 40, wherein the microstructure for moving the lipid phase is integrated in the flow of fluid or in the form of a hanging drop in a pipetting robot.

55. The measuring arrangement as claimed in claim 40, wherein the microstructure is connected to a pump for generating flows of fluid in the microstructure.

56. The measuring arrangement as claimed in any one of claims 40 to 55, with a lipid bilayer over the microcavity, wherein at least one membrane protein, which spans over the membrane or is associated with it, is located in the lipid bilayer, so that the lipid bilayer receives at least an ionic conductivity and/or at least one other biophysical property detectable with electrical or optical methods.
